(19) United States
(12) Patent Application Publication
(10) Pub. No.: US 2003/0184856 A1
(43) Pub. Date: Oct. 2, 2003

(54) Focus point detection device and microscope using the same

(75) Inventor: Tatsuro Otaki, Tokyo (JP)

Correspondence Address: MILES & STOCKBRIDGE PC, 1751 PINNACLE DRIVE, SUITE 500, MCLEAN, VA, 22102-3833, US

(73) Assignee: Nikon Corporation

(21) Appl. No.: 10/402,999

(22) Filed: Apr. 1, 2003

(30) Foreign Application Priority Data
Apr. 2, 2002 (JP) 2002-100242

(51) Int. Cl. G02B 21/06

(52) U.S. Cl. 359/383; 359/368; 359/385; 250/201.3

(57) ABSTRACT

A focus point detection device comprises an illuminator that illuminates a specimen obliquely by letting a light flux at an angle to an optical axis of an objective lens enter in such a way that the optical axis and the light flux cross each other in the vicinity of a point in focus at an object side of the objective lens, an image-forming device that forms an image of the observation plane by converging a light from the observation plane of the specimen via the objective lens and a light amount detector that detects amount of light in response to the image formed by the image-forming device with a light sensor, wherein the light amount detector detects a light other than a regular reflection light from a surface of the specimen. Also, a fluorescence microscope comprises the focus point detection device and the infinity objective lens.

This application is based upon and claims priority of Japanese Patent Application No. 2002-100242 filed on Apr. 02, 2002, the contents being incorporated herein by reference.

### BACKGROUND OF THE INVENTION

1. Field of the Invention

The present invention relates to a focus point detection device and a microscope using the same, and more particularly to a suitable focus point detection device when applying to an auto focusing mechanism of an optical apparatus and a fluorescence microscope using the same.

2. Related Background Art

In this field of the art, an optical apparatus such as a microscope and a camera has been provided with an auto focusing mechanism to form a clear object image on a given image plane (for example, an image-forming surface of an imaging sensor). Also, an important part of an auto focusing mechanism is a focus point detection device to detect a shift or deviation in position (a focus shift or deviation) between an image formed by an optical system and a given image plane. As for a focus point detection device, a method for capturing an object as an image and detecting a focus point based on changes in contrast of an image (for example, Japanese Patent No. 3239343) is known. Further, a method for guiding a light from a light source into an observation plane via a slit and a shield element and performing a focus point detection based upon a position of light gravity center of a return light from an observation plane (for example, U.S. Pat. No. 5,483,079) is also known.

### SUMMARY OF THE INVENTION

However, a conventional image contrast method is susceptible to an effect of amount of light originating from an object. Thus, if amount of light originating from an object is low, it would take much time to detect a focus point or focus point detection would become rather difficult. Also, in the slit method, as light gravity center of a light regularly reflected on an observation plane is detected, a detection speed becomes fast in comparison with that of a contrast method. But, as only a reflection light from a plane with the largest difference in refractive index in the observed specimens such as an interface between the air and a cover glass, between a cover glass and a specimen and so on is detectable, a direct focus point detection of a given position in a depth direction of a specimen to be observed has been impossible.

It is an object of the present invention to provide a focus point detection device enabling optimum focus detection even in a low light condition and a microscope including the same.

In order to achieve the object, according to a first feature of the present invention, there is provided a focus point detection device which includes an illuminator that illuminates a specimen obliquely by letting a light flux at an angle to an optical axis of an objective lens enter in such a way that the optical axis and the light flux cross each other in the vicinity of a focus point at an object side of the objective lens, an image-forming device that forms an image of an observation plane by converging a light from the observation plane of the specimen via the objective lens and a light amount detector that detects amount of light in response to the image formed by the image-forming device with a light sensor, wherein the light amount detector detects light other than regular reflection light from a surface of the specimen.

According to a second feature of the present invention, there is provided a focus point detection device, wherein a light sensing field stop may be disposed on a plane conjugate with a focus point and the light amount detector detects amount of light with the light sensor disposed behind the light sensing field stop via the light sensing field stop.

According to a third feature of the present invention, in the focus point detection device, the illuminator may have an illumination field stop defining an illumination area of the observation plane and the illumination field stop is similar in figure to the light sensing field stop.

According to a fourth feature of the present invention, in the focus point detection device, the focus point detection device may have an adjuster that adjusts sizes of the illumination field stop and the light sensing field stop.

According to a fifth feature of the present invention, in the focus point detection device, the focus point detection device may have an auxiliary light sensor and an auxiliary light sensing field stop respectively disposed behind a plane conjugate with the focus point and a direction detector that detects a direction of a shift in position of the specimen in response to amount of light entering the auxiliary light sensor.

According to a sixth feature of the present invention, in the focus point detection device, the illuminator may be to illuminate the observation plane obliquely via an objective lens of an infinity optical system and have an aperture stop on a location conjugate with a pupil plane of the objective lens.

According to a seventh feature of the present invention, in the focus point detection device, the aperture stop may include an aperture off an optical axis of the pupil plane.

According to a eighth feature of the present invention, in the focus point detection device, a photomultiplier may be used as the light amount detector.

According to a ninth feature of the present invention, in the focus point detection device, the light amount detector may approximate changes in amount of light in front of and behind a point in focus to straight lines respectively and let a meeting point of two straight lines be a point in focus.

According to a tenth feature of the present invention, in the focus point detection device, an optical axis of the image-forming device may be approximately normal to the observation plane.

According to a eleventh feature of the present invention, there may be provided a microscope with the focus point detection device of the first feature, wherein the objective lens is an infinity optical system.

According to a twelfth feature of the present invention, in the microscope of the eleventh feature, the microscope may have a switching controller that switches between illumination timing by the illuminator of the focus point detection device and illumination timing by the observing illuminator.

According to a thirteenth feature of the present invention, in the microscope of the twelfth feature, the illuminator of the focus point detection device may have an aperture stop disposed on a location conjugate with a pupil plane of the objective lens and the switching controller may be to detach the aperture stop out of an optical axis of the illuminator.

According to a fourteenth feature of the present invention, there is provided a focus point detection device includes an illuminator that illuminates a specimen obliquely, an image-forming device that forms an image of an observation plane by converging a light from the observation plane of the specimen via an objective lens and a photoelectric detector that detects amount of light in response to the image formed by the image-forming device with a light sensor, wherein an illumination light illuminated by the illuminator is different in a wave band from a detection light entering the light sensor.

According to a fifteenth feature of the present invention, in the focus point detection device of the fourteenth feature, the image-forming device may have a wavelength selector.

According to a sixteenth feature of the present invention, there is provided a microscope with a focus point detection device of the fifteenth feature, wherein the objective lens may be an infinity optical system, the illuminator may illuminate the observation plane obliquely and the image-forming device may form an image of the observation plane via the objective lens.

According to a seventeenth feature of the present invention, in the microscope of the sixteenth feature, the microscope may include an observing illuminator that illuminates the specimen via the objective lens with a light for observation when observing the observation plane and a switching controller that switches between illumination timing by the illuminator of the focus point detection device and illumination timing by the observing illuminator.

According to a eighteenth feature of the present invention, in the microscope of the seventeenth feature, the illuminator may have an aperture stop on a location conjugate with a pupil of the objective lens and the switching controller may be to detach the aperture stop out of an optical axis of the illuminator.

According to a nineteenth feature of the present invention, there is provided a focus point detection device includes an illuminator that illuminates a specimen obliquely, an image-forming device that forms an image of an observation plane by converging a light of the observation plane of the specimen via an objective lens and a light amount detector that detects amount of light in response to the image formed by the image-forming device with a light sensor, wherein the illuminator illuminates the specimen obliquely with a light of a wave band enabling to excite fluorescent material contained in the observation plane and the light amount detector detects amount of fluorescence entering the light sensor.

According to a twentieth feature of the present invention, there is provided a fluorescence microscope with an objective lens of an infinity optical system and a focus point detection device of the nineteenth feature, wherein the illuminator may illuminate the observation plane obliquely via the objective lens and the image-forming device may form the fluorescence image of the observation plane via the objective lens.

Other feature and advantages according to this invention will be readily understood from the detailed description of the preferred embodiments in conjunction with the accompanying figures.

### BRIEF DESCRIPTION OF THE DRAWINGS

FIG. 1 is an overall configuration diagram of focus point detection device 10 of a first embodiment according to the present invention.

FIGS. 2A-2C are diagrams explaining a principle of the focus point detection device 10.

FIG. 3 is a diagram explaining a principle of the focus point detection device 10.

FIG. 4 is a diagram explaining a principle of adjusting a focus detection range and accuracy in focus detection.

FIGS. 5A-5C are diagrams of major parts of a configuration of a focus point detection device of a second embodiment according to the present invention.

FIG. 6 is a diagram showing a whole configuration of fluorescence microscope 50 and focus point detection device 40 of a third embodiment according to the present invention.

FIG. 7 is a flow chart about a switching control of illumination timing in fluorescence microscope 50.

FIGS. 8A and 8B are diagrams showing another configuration of illuminating filed stop 16 and light sensing field stop 20.

### DETAILED DESCRIPTION OF THE PREFERRED EMBODIMENTS

A first embodiment of the present invention will be described.

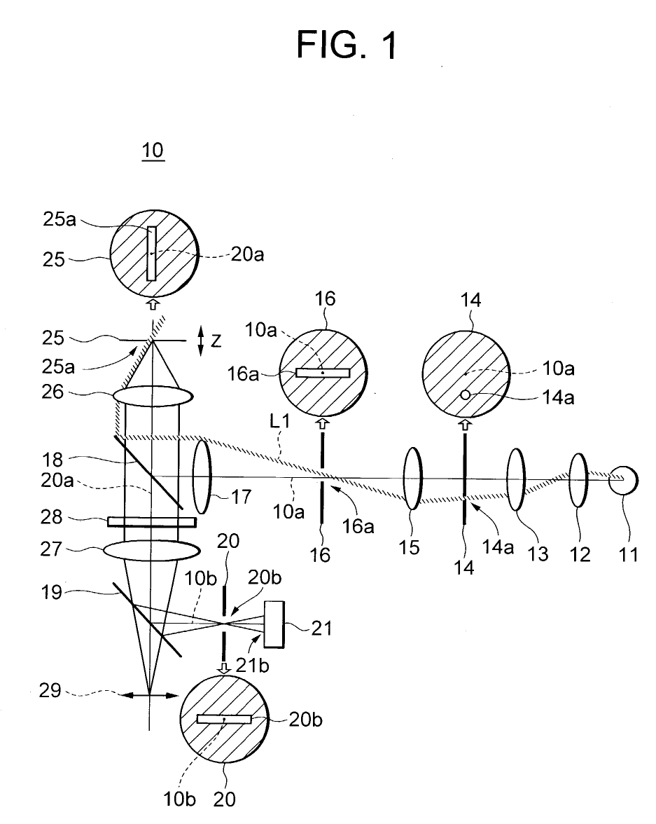

Herein, as shown in FIG. 1, the embodiment is related to a focus point detection device 10 built in an observing optical system (26-28) forming a fluorescence image of a specimen 25. Specimen 25 (an object) is, for example, a living specimen (such as DNA or a protein or so) labeled by a fluorescent material. This specimen 25 is put on a stage (not shown) and movable along in a direction of an optical axis 20a of an observing optical system (26-28). Let the direction of the optical axis 20a be a Z direction. FIG. 1 illustrates a state that the specimen 25 comes to a focus position (being in focus) of the observing optical system (26-28). A position Z of the specimen 25, in this case, is referred to as an in-focus position. Before touching on a focus point detection device 10, a configuration of the observing optical system (26-28) will be explained. The observing optical system (26-28) includes an infinity objective lens 26, image-forming lens 27 functioning as a second objective lens and wavelength selection filter 28 placed between the objective lens 26 and the image-forming lens 27. The wavelength selection filter 28 has a characteristic of letting fluorescence (for example, 520 nm-600 nm) radiated from the specimen 25 selectively pass through.

At a fluorescence observation of the specimen 25, fluorescence radiated from the in-focused specimen 25 is converged on a given image plane 29 conjugate with a position of the in-focused specimen 25 through the objective lens 26 and the image-forming lens 27. In this case, a fluorescence image of the specimen 25 is clearly formed on the given image plane 29. A two-dimensional (2D)-imaging sensor (for example, a CCD image. sensor) is disposed on a given image-forming plane 29 (or a plane conjugate with the image-forming plane), although not shown. When the specimen 25 is in focus, a 2D-imaging sensor can obtain a clear fluorescence image of the specimen 25. In the first embodiment, let an observing magnification power of the objective lens 26 and the image-forming lens 27 be 20 times respectively and a numerical aperture of the objective lens 26 be 0.4.

The focus point detection device 10 of the first embodiment is to detect whether or not the specimen 25 is in focus and includes an illuminating optical system (11-18) and a light receiving optical system (19-21). Further, the foregoing observing optical system (26-28) acts as the focus point detection device 10. Thus, as a component of the focus point detection device 10, the focus point detection device 10 includes not only the illuminating optical system (11-18) and the light receiving optical system (19-21), but also the observing optical system (26-28).

A configuration of an illuminating optical system (11-18) is concretely explained. The illuminating optical system (11-18) is so configured in a way that along in a direction of the optical axis 10a, a light source 11, lenses 12-13, an aperture stop 14, a lens 15, an illuminating field stop 16, a lens 17 and a dichroic mirror 18 are arranged in order.

The illuminating optical system (11-18) is disposed in between the objective lens 26 of the observing optical system (26-28) and the wavelength selection filter 28 with the optical axis 10a of the illuminating optical system (11-18) almost normal to the optical axis 20a of the foregoing observing optical system (26-28). In this case, a dichroic mirror 18 of the illuminating optical system (11-18) is arranged on the optical axis 20a.

Light source 11 of the illuminating optical system (11-18) is, for example, a high-pressure mercury-vapor lamp generating an excitation light, such as an ultraviolet ray and a visible light. The excitation light is light with a wave band (for example, less than 505 nm) enabling to excite a fluorescent material contained in the specimen 25. The excitation light from the light source 11 reaches an aperture stop 14 after through the lenses 12-13.

The aperture stop 14 is disposed on a plane conjugate with a pupil plane (an image-side focal plane) of the objective lens 26 of the observing optical system (26-28). The aperture stop 14 includes a circular aperture 14a off the optical axis 10a of the illuminating optical system (11-18). Excitation light passing through the aperture 14a of the aperture stop 14 reaches the illuminating field stop 16 after through the lens 15.

The illuminating field stop 16 is disposed on a plane conjugate with the position of the in-focused specimen 25 and the image plane 29. The illuminating field stop 16 includes a slit-shaped aperture 16a on the optical axis 10a of the illuminating optical system (11-18). A length direction of the aperture 16a is normal to a drawing paper plane. Excitation light Li passing through the aperture 16a of the illuminating field stop 16 advances in an oblique direction to the optical axis 10a and via the lens 17, reaches the dichroic mirror 18.

The dichroic mirror 18 has a characteristic of, for example, reflecting a light wavelength of less than 505 nm and transmitting a light wavelength of more than 505 nm. Thus, excitation light from the light source 11 is reflected by the dichroic mirror 18 and via the objective lens 26 of the observing optical system (26-28), and reaches the specimen 25. In the meantime, fluorescence (for example, wavelength 520 nm-600 nm) from the specimen 25 is transmitted through the dichroic mirror 18.

As in the foregoing, the illuminating optical system (11-18) is an episcopic illuminating optical system that illuminates specimen 25 with the objective lens 26. And in this illuminating optical system, as the aperture 14a of the aperture stop 14 is placed off the optical axis 10a, excitation light LI passing through the aperture 16a of the illuminating field stop 16 is enabled to advance in an oblique direction to the optical axis 10a and then, illuminates the specimen 25 obliquely.

An oblique illumination is a way of radiating excitation light onto the specimen 25 from an oblique direction to the optical axis 20a of the observing optical system (26-28). Precisely speaking, a direction of a principal ray of excitation light incident upon the specimen 25 is oblique to the optical axis 20a.

Further, in the illuminating optical system (11-18), since the aperture stop 14 is in a conjugate relationship with a pupil plane of the objective lens 26, a direction of a principal ray of excitation light incident upon the specimen 25 can be made parallel to each other. Therefore, accuracy in focus point detection in accordance with the focus point detection device 10 of the first embodiment is improved.

In the illuminating optical system (11-18), as the aperture stop 14 is disposed in conjugate with a pupil plane of the objective lens 26 and the illuminating field stop 16 is in conjugate with the in-focused specimen 25 and the image plane 29, a so-called Koehler illumination can be realized.

Further, in the illuminating optical system (11-18), as the aperture 16a of the illuminating field stop 16 is elongate slit-shaped, an illumination area 25a of the specimen 25 can be made as an elongate slit shape. A lengthwise direction of the illumination area 25a is also normal to the drawing paper plane. The illumination area 25a and the aperture 16a of the illuminating field stop 16 are similar figures. In the first embodiment, let the width of the illumination area 25a be 0.005 mm.

Now, in the illumination area 25a of the specimen 25, the optical axis 20a of the observing optical system (26-28) is included. Particularly, when the specimen 25 is in focus, the center of the illumination area 25a coincides with the optical axis 20a of the observing optical system (26-28). The optical axis 20a corresponds to the center of the field of view (an observing field of view) for a fluorescence observation of the specimen 25.

As in the foregoing, the specimen 25 obliquely illuminated by the illuminating optical system (26-28) and the objective lens 26 gets excited within the illumination area 25a and radiates fluorescence from the illumination area 25a. Such fluorescence is converged by the objective lens 26 and the image-forming lens 27 in the same way as the fluorescence observation and is led to a light receiving optical system (19-21).

As the dichroic mirror 18 and the wavelength selection filter 28 are disposed between the objective lens 26 and the image-forming lens 27, excitation light (for example, having wavelength less than 505 nm) reflected upon the specimen 25 is shut off and only fluorescence (for example, wavelength in the range of 520 nm-600 nm) generated at the specimen 25 can be led to the light receiving optical system (19-21).

When the specimen 25 is, for example, a living specimen, because the amount of fluorescence from the specimen 25 is generally very low (less than 0.01) compared with excitation light irradiated onto the specimen 25, fluorescence from the specimen efficiently can be collected by the dichroic mirror 18 and the wavelength selection filter 28.

Next, a configuration of the light receiving optical system (19-21) is concretely explained. The light receiving optical system (19-21) is so configured in a way that along on an optical axis 10b, a half mirror 19, a light sensing field stop 20 and a photoelectric detector 21 are arranged in order.

The light receiving optical system (19-21) is arranged into between the image-forming lens 27 of the observing optical system (26-28) and the given image-forming plane 29 with the optical axis 10b of the light receiving optical system (19-21) approximately normal to the optical axis 20a of the foregoing observing optical system (26-28). In this case, the half mirror 19 of the light receiving optical system (19-21), is disposed on the optical axis 20a. Therefore, fluorescence which is generated from the illumination range 25a of the specimen 25 obliquely illuminated by the illuminating optical system (11-18) and the objective lens 26 and thereafter is converged by the objective lens 26 and the image-forming lens 27 (hereafter this fluorescence is called fluorescence at focus point detection) reaches the light sensing field stop 20 after being reflected upon the half mirror 19.

The light receiving field stop 20 is disposed on a plane conjugate with the position of the in-focused specimen 25 and the image plane 29. The light sensing field stop 20 is provided with slit-shaped aperture 20b (details will be explained later) on the optical axis 10b of the light receiving optical system (19-21). A lengthwise direction of the aperture 20b is normal to the drawing paper plane.

When the specimen 25 is in focus, fluorescence at focus point detection generated from the illumination area 25a of the specimen 25 is optimally converged on an arrangement plane (a plane conjugate with the position of the in-focused specimen 25). Namely, a clear fluorescence image of the illumination area 25a of specimen 25 is formed on a plane on which the light receiving field stop 20 is disposed.

Here now, the aperture 20b of the field stop 20 will be concretely explained. The aperture 20b of the light sensing field stop 20 is similar in figure to the aperture 16a of the illuminating field stop 16. Thus, the aperture 20b becomes similar in figure to the illumination area 25a of the specimen 25 and also to a fluorescence image of the illumination range 25a of the specimen 25.

In the focus point detection device 10 of the first embodiment, the size of the aperture 20b of the light sensing field stop 20 is so determined as to coincide with the size of the fluorescence image of the illumination range 25a. For example, let width of the illumination area 25a be 0.05 mm, an observing magnification power of the objective lens 26 and the image-forming lens 27 be 20×, then the width of the fluorescence image of the illumination area 25a becomes 1 mm. In this case, width of the aperture 20b of the light receiving field stop 20 is also set at 1 mm.

Therefore, when the specimen 25 is in focus, a fluorescence image of the illumination area 25a formed on the plane of the light sensing field stop 20 overlaps the aperture 20b of the light sensing field stop 20 and passes through the aperture 20b as it is. Then, fluorescence at focus point detection having passed through the aperture 20b of the light sensing field stop 20 reaches the photoelectric detector 21.

The photoelectric detector 21 is formed with a light receiving surface 21b disposed behind the plane of the light sensing field stop 20 (a plane conjugate with the position of the specimen 25 and the image plane 29). A center of the light receiving surface 21b is positioned on the optical axis 10b of the light receiving optical system (19-21). A fluorescence image (blurred fluorescence image) passing through the aperture 20b of the light sensing field stop 20 is formed on the light receiving surface 21b.

And then, the photoelectric detector 21 collectively detects the amount of the light incident upon the light receiving surface 21b depending on a blurred fluorescence image formed on the light receiving surface 21b. As the photoelectric detector 21, for example, a photomultiplier and the like suitable for detecting a small amount of light may be preferable for use. Anyway, the illuminating optical system (11-18) and the objective lens 26 of the focus position detection device 10 so configured as in the foregoing correspond to an illuminator set forth in claims. The observing optical system (26-28) and the half mirror 19 also correspond to an image-forming device set forth in claims, and the photoelectric detector 21 corresponds to a light amount detector set forth in claims respectively.

If the aperture stop 14 is detachable from the optical path of the illuminating optical system, an observation light can be guided by removing the aperture stop from the optical path. Thus, a member for detaching the aperture stop corresponds to a switching controller set forth in claims.

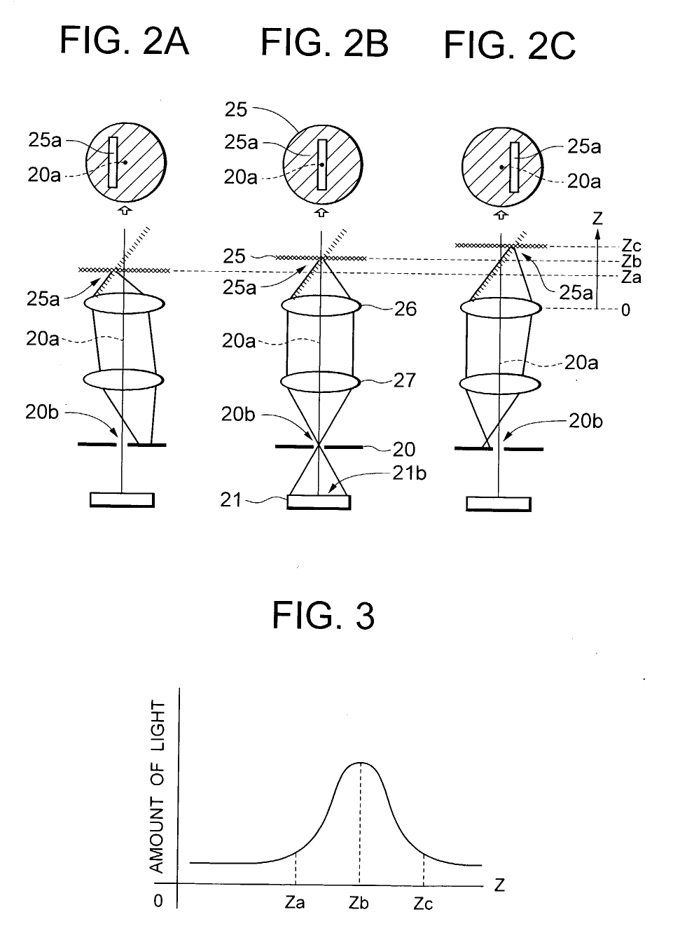

Next, a principle of detecting a focus point in the focus point detection device 10 of the first embodiment, is explained by referring to FIGS. 2A-2C and 3. FIGS. 2A-2C illustrate only necessary parts (specimen 25, objective lens 26, image-forming lens 27, light sensing field stop 20 and photoelectric detector 21) for explaining the principle. FIG. 2A shows a so-called “front focus” state, FIG. 2B shows an “in-focus” state, and FIG. 2C shows a so-called “rear or behind focus” state. FIG. 3 shows changes in amount of light detected by the photoelectric detector 21 when a distance along the optical axis between the specimen 25 and the objective lens 26, that is, z position of the specimen 25 in the direction of the optical axis varies.

At an in-focus state as shown in FIG. 2B, the center of the illumination area 25a of the specimen 25 coincides with the optical axis 20a of the objective lens 26 and the image-forming lens 27. Thus, a fluorescence image of the illumination area 25a of the specimen 25 is formed on a location at which the aperture 20b of the light sensing field stop 20 is located. And all fluorescence involving in forming the fluorescence image pass completely through the aperture 20b. Therefore, amount of light detected by the photoelectric detector 21 becomes maximum.

On the other hand, at a “front focus” state as shown in FIG. 2A, the illumination area 25a of the specimen 25 becomes off the optical axis 20a and positioned at a left side of the optical axis in FIG. 2. The reason is that the specimen 25 is illuminated from a left side in FIG. 2A. In this case, a fluorescence image of the illumination area 25a of the specimen 25 is formed off the aperture 20b of the field stop 20 and positioned at a right side in FIG. 2A. Thus, fluorescence which otherwise involves in forming a fluorescence image can not pass through the aperture 20b and then amount of light detected by the photoelectric detector 21 becomes almost zero.

On the contrary, at a “rear or behind focus” state as shown in FIG. 2C, the illumination area 25a of the specimen 25 becomes off the optical axis 20a and positioned at a right side in FIG. 2C. The reason is that the specimen 25 is illuminated from a right side in FIG. 2A. In this case, a fluorescence image of the illumination range 25a of the specimen 25 is formed off the aperture 20b of the light sensing field stop 20 and positioned at a left side in FIG. 2C. Thus, fluorescence which otherwise involves in forming the fluorescence image can not pass through the aperture 20b and then amount of light detected by the photoelectric detector 21 becomes almost zero.

Therefore, in accordance with the focus point detection device 10 of the first embodiment, focus detection can be performed, by moving the specimen 25 in the Z direction and monitoring amount of light detected by the photoelectric detector 21. A point at which amount of light detected by the photoelectric detector 21 gets at a maximum level (a position Zb in FIG. 3) can be judged to be the position of the in-focused specimen 25.

In the foregoing focus point detection device 10 of the first embodiment, as observing magnification powers of the objective lens 26 and the image-forming lens 27 are set at 20× respectively, a position of the fluorescence image of the illumination area 25a shifts or deviates by 0.2 mm in a horizontal direction on a plane which the light receiving field stop 20 is arranged on, when a position of specimen 25 moves by 0.01 mm in the direction of the optical axis.

As width of the aperture 20b of the light sensing field stop 20 is 1 mm, amount of light detected by the photoelectric detector 21 varies by 20% or so when a fluorescence image of the illumination area 25a shifts or deviates in position by 0.2 mm in a widthwise direction of the aperture 20b. Thus, even in a case where the specimen 25 is like a living specimen of 0.05 mm or so in thickness, a reasonably necessity-filled sufficient focus point detection can be performed by monitoring amount of light detected by the photoelectric detector 21.

As explained in the foregoing, in accordance with the focus point detection device 10 of the first embodiment, since focus point detection is performed by monitoring change in amount of light of the fluorescence image of the specimen 25, focus point detection can be optimally carried out in a short time even when the amount of light from the specimen 25 is dim or so small at a fluorescence observation of the specimen 25.

By combination of the above mentioned focus point detection device 10 with a control device judging whether or not the detected amount of light gets at a peak by monitoring amount of light detected by the photoelectric detector 21 while moving the specimen 25 in the Z direction and, highly accurate automatic focus point detection can be performed even when amount of light from the specimen 25 is dim or so small.

Further, according to the focus point detection device 10 of the first embodiment, as the illumination area 25a of the specimen 25 is slit-shaped, even in a case where fluorescent materials contained in the specimen 25 are sparsely spread, amount of light for detection by the photoelectric detector 21 can be secured and focus point detection can be optimally carried out in a short time. In this case, an averaged in-focused position within the illumination area 25a of the specimen 25 can be obtained.

As the focus point detection device 10 of the first embodiment is provided with the light sensing field stop 20 on a plane conjugate with the position of the in-focused specimen 25, size of the aperture 20b of the field stop 20 is variable in response to change in size of the fluorescence image (which corresponds to the illumination range 25a of the specimen 25) on the plane on which the field stop member 20 is arranged, just like a case where an observing magnification power of the specimen 25 is varied by replacing the objective lens 26 of the observing optical system (26-28). That is, focus point detection can be optimally performed in a short time even if an observing magnification power is varied.

Further, by providing means for adjusting widths of the apertures 16a and 20b of the illuminating field stop 16 and the light sensing field stop 20, widths of two apertures 16a and 20b may be adjusted while similarity in figures of two apertures 16a and 20b are maintained, in other words, while size of fluorescence image (which corresponds to the illumination area 25a of the specimen 25) on the plane which the light receiving field stop 20 is arranged on is made coincide with size of the aperture 20b, widths of two apertures 16a and 20b may be adjusted.

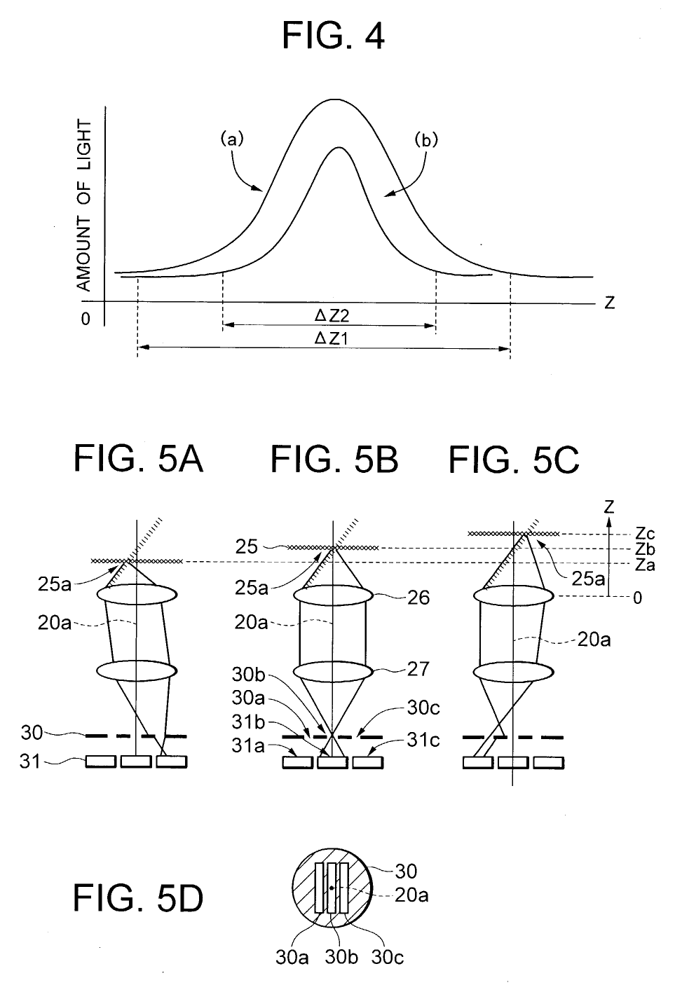

For example, when adjusting widths of two apertures 16a and 20b by two steps, amount of light detected by the photoelectric detector 21 changes as shown by the curves (a) and (b) in FIG. 4. The curves (a) in FIG. 4 corresponds to a case of widths of the apertures 16a and 20b being broad, and the curve (b) is a case where widths of the apertures 16a and 20b are narrow.

As seen from a comparison of the curves (a) and (b) in FIG. 4, a focus point detection scope (ΔZ1) of the curve (a) where widths of apertures 16a and 20b are broadened becomes greater than that (ΔZ2) with narrowed widths of the curve (b). With respect to an accuracy of the focus point detection, narrowed widths of the apertures 16a and 20b as shown by the curve (b), improve accuracy compared with broadened ones of the curve (a).

Thus, firstly, widths of the apertures 16a and 20b are made broaden and rough focus point detection is performed within a wider focus point detection scope (ΔZ1), and then widths of the apertures 16a and 20b are changed to narrow one, thereby focus detection within a narrowed focus point detection scope (ΔZ2) can be performed accurately. Though the light receiving optical system (19-20) is disposed between the image-forming lens 27 and the image plane 29 in the foregoing first embodiment, it may be disposed between the image-forming lens 27 and the wavelength selection filter 28. In this case, however, an optical element having an equivalent function to the image-forming lens 27 is required to be disposed between the half mirror 19 of the light receiving optical system (19-20) and the light sensing field stop 20.

Further, the light receiving optical system (19-20) may be disposed between the wavelength selection filter 28 and the objective lens 26. In this case, however, the optical elements having equivalent functions to the image-forming lens 27 and the wavelength selection filter 28 are required to be disposed respectively between the half mirror 19 of the light receiving optical system (19-20) and the light sensing field stop 20.

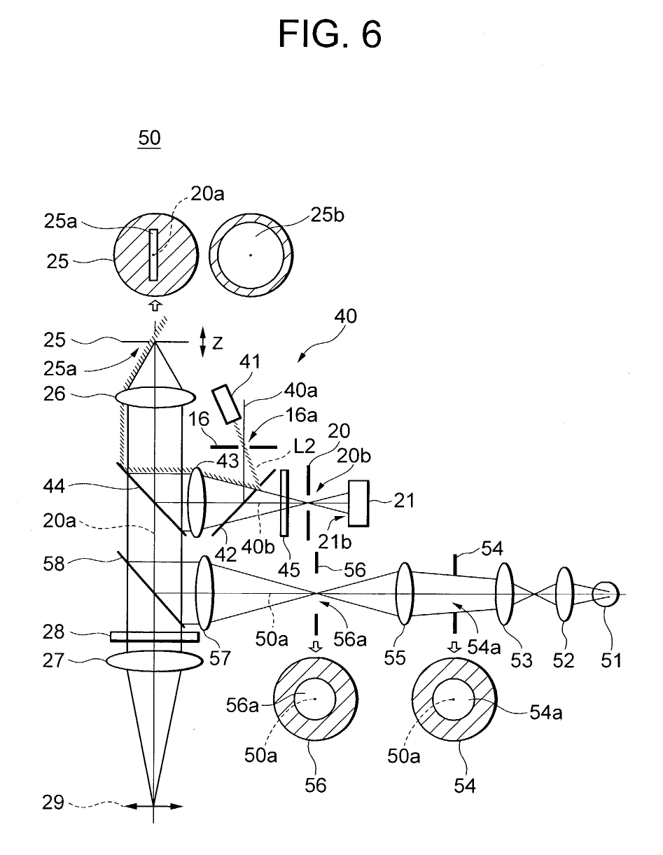

This last mentioned case has an advantage that the light receiving optical system (19-20, optical elements equivalent to the image-forming lens 27 and the wavelength selection filter 28 included) and the illuminating optical system (11-18) can be unitized. An example of this unitized configuration will be explained later as a focus point detection device 40 (FIG. 6) of a third embodiment of the present invention.

Further, in the foregoing first embodiment, the excitation light is led to the aperture stop 14 by the light source 11 and the lenses 12-13 in the illuminating optical system (11-18), but the other light source such as a compact semiconductor laser, LED or so instead of the light source 11 and the lenses 12-13 may be disposed in the neighborhood of the aperture 14a of the aperture stop 14. Also, though the excitation light is led to the illuminating field stop 16 by the light source 11, lenses 12-13, aperture stop 14 and lens 15 in the illuminating optical system (11-18) of the foregoing first embodiment, another light source such as a compact semiconductor laser, LED or so instead of these optical elements (11-15) may be disposed near the aperture 16a of the illuminating field stop 16. An example of such configuration will be explained later with respect to the focus point detection device 40 (FIG. 6) of the third embodiment.

A second embodiment of the present invention will be described next. A focus point detection device of the second embodiment is, as shown in FIGS. 5A-5C, is provided with a light sensing field stop 30 instead of the light sensing field stop 20 of the focus point detection device 10 shown in FIGS. 1-2C in the first embodiment and a photoelectric detector 31 instead of the photoelectric detector 21 of the focus point detection device 10 shown in FIGS. 1-2C in the first embodiment. The locations of the light sensing field stop 30 and the photoelectric detector 31 are the same as those of the light sensing field stop 20 and the photoelectric detector 21. FIGS. 5A-5C are, like FIGS. 2A-2C, diagrams illustrating only necessary parts (specimen 25, objective lens 26, image-forming lens 27, light sensing field stop 30 and photoelectric detector 31) for explaining the principle.

The light sensing field stop 30 is provided with three apertures 30a, 30b and 30c. The apertures 30a-30c are slit-shaped respectively and the aperture 30b in the middle is disposed on the optical axis of a light receiving optical system (19, 30, 31). Lengthwise directions of the apertures 30a-30c are normal to the drawing paper plane. Further, the size of the aperture 30b is so set as to coincide with the size of fluorescence image (which corresponds to the illumination area 25a of the specimen 25) formed on the plane which the light sensing field stop 30 is arranged, just as in the case of the aperture 20b of the light sensing field stop 20 in the first embodiment.

The photoelectric detector 31 is provided with three separate light receiving surfaces 31a, 31b and 31c corresponding to the respective apertures 30a-30c of the light sensing field stop 30. Light receiving surface 31b in the middle is disposed on the optical axis of the light receiving optical system (19, 30, 31) just like the light sensing plane 21b of the photoelectric detector 21. Thus, a fluorescence image (blurred fluorescence image) after passing through the aperture 30b in the middle of the light sensing field stop 30 is formed on the light receiving surface 31b in the middle of the photoelectric detector 31. Also, fluorescence images after passing through apertures 30a and 30c on both sides of the light sensing field stop 30 are formed on the light receiving surfaces 31a and 31c on both sides.

The photoelectric detector 31 detects collectively amount of light entering the light receiving surface 31b in response to a blurred fluorescence image formed on the light receiving surface 31b in the middle. Similarly, the photoelectric detector 31 detects collectively the respective amounts of light entering the light receiving surfaces 31a and 31c in response to the respective blurred fluorescence images formed on the light receiving surfaces 31a and 31c on both sides. The light receiving surfaces 31a and 31c on both sides of the photoelectric detector 31 composes an auxiliary light sensing surface. The light receiving surfaces 31a and 31c on both sides of the photoelectric detector 31 composes a direction detector and the light receiving surface 31b in the middle composes to a light amount detector.

In the focus point detection device of the second embodiment, the light sensing field stop 30 and the photoelectric detector 31 are so configured as in the foregoing, so focus point detection is performed as blow.

When a focus status is as shown in FIG. 5B, the center of the illumination area 25a of the specimen 25 coincides with the optical axis 20a of the objective lens 26 and the image-forming lens 27 and a fluorescence image of the illumination range 25a of the specimen 25 is formed on a location that overlaps aperture 30b in the middle of the light sensing field stop 30. And all fluorescent light rays involving in forming the fluorescence image pass through aperture 30b as they are. Thus, amount of light detected on the light sensing surface 31b in the middle of photoelectric detector 31 becomes at a peak (see FIG. 3).

In a case of the “front focus” state, as shown in FIG. 5A, the illumination range 25a of the specimen 25 becomes off the optical axis 20a and is positioned on the left in FIG. 5A. In this case, a fluorescence image of the illumination area 25a of the specimen 25 is formed off the aperture 30b in the middle of light sensing field stop 30 and formed on the right (for example, a location which overlaps the aperture 30c on the right) in FIG. 5A. Thus, fluorescence which otherwise involves in forming the fluorescence image can not pass through the aperture 30b in the middle and then the amount of light detected by the light sensing surface 31b in the middle of the photoelectric detector 31 becomes almost zero. But, this fluorescence is transmitted through the aperture 30c on the right and the amount of light can be detected on the light sensing surface 31c on the right side of the photoelectric detector 31. Then, based upon the amount of light detected on the light sensing surface 31c on the right, it becomes detectable that the specimen 25 is shifted or deviated into the direction of the “front focus”.

On the contrary, in a case of a “rear or behind focus” state as shown in FIG. 5C, the illumination area 25a of the specimen 25 becomes off the optical axis 20a and positioned on the right in FIG. 5C. In this case, a fluorescence image of the illumination area 25a of the specimen 25 is formed off the aperture 30b in the middle of the light sensing field stop 30 and formed on the left (for example, a location which overlaps the aperture 30a on the left) in FIG. 5C. Thus, fluorescence which otherwise involves in forming a fluorescence image can not pass through the aperture 20b in the middle and then the amount of light detected by the light sensing surface 31b in the middle of the photoelectric detector 31 becomes almost zero. But, this fluorescence is transmitted through the aperture 30a on the left and the amount of light can be detected on the light sensing surface 31a on the left side of the photoelectric detector 31. Based upon the amount of light detected on the light sensing surface 31a on the left, it becomes detectable that the specimen 25 is shifted or deviated in the direction of the “rear focus”.

Therefore, in the focus point detection device of the second embodiment, the amounts of light detected respectively by the light sensing surfaces 31a and 31c on both side of the photoelectric detector 31 are monitored while moving specimen 25 in the Z direction, thereby a direction in which the specimen 25 is deviated can be detected and a focus point detection can be performed, by checking the amount of light detected by the light sensing surface 31b in the middle of the photoelectric detector 31. A point (point Zb in FIG. 3) where the amount of light detected by light sensing surface 31b in the middle of the photoelectric detector 31 reaches a peak is judged that the specimen 25 is in-focused.

As explained in the foregoing, in the focus point detection device of the second embodiment, a focus point detection is performed by monitoring change in amount of light of fluorescence image of the specimen 25, so even if the amount of light from the specimen 25 is dim or small a focus point detection is optimally enabled in a short time.

A third embodiment of the present invention will be described next.

In the third embodiment, an example of fluorescence microscope 50 having a focus point detection device 40 assembled therein is explained. Fluorescence microscope 50 is a microscope used for a fluorescence observation of a specimen 25 labeled by a fluorescent material and includes the same observing optical system (26-28) as in the foregoing embodiments and an observing illumination optical system (51-58) to be explained later. A basic configuration of the observing illumination optical system (51-58) of the fluorescence microscope 50 is the same as that of the illuminating optical system (11-18) of the focus point detection device 10. Namely, it is configured in such a way that light source 11, lenses 52-53, aperture stop 54, lens 55, illuminating field stop member 56, lens 57 and dichroic mirror 58 are arranged in order along on an optical axis 50a.

The observing illumination optical system (51-58) is arranged in between the objective lens 26 of the observing optical system (26-28) and the wavelength selection filter 28 with the optical axis 50a of the observing illumination optical system (51-58) approximately normal to the optical axis 20a of the observing optical system (26-28). In this case, a dichroic mirror 58 of the observing illumination optical system (51-58) is disposed on the optical axis 20a. Difference of an observing illumination optical system (51-58) from the illuminating optical system (11-18) of FIG. 1 is in shape and size of an aperture 54a of the aperture stop 54 and shape and size of an aperture 56a of the aperture stop 56. Thus, the other explanations except for the shape and size with regard to the observing illumination optical system (51-58) are omitted.

The aperture 54a of the aperture stop 54 has a circular shape with a large diameter and the aperture stop 54 is disposed with the center of the aperture 54a being aligned with the optical axis 50a of the observing illumination optical system (51-58). The aperture 56a of the illuminating field stop 56 is also circular and has a large diameter and the aperture stop 56 is disposed with the center of the aperture 54a being aligned with the optical axis 50a of the observing illumination optical system (51-58). An observing illumination optical system (51-58) composes an observing illuminator.

In the observing illumination optical system (51-58) configured as in the foregoing, excitation light (light enabling to excite a fluorescent material of the specimen 25) from the light source 51 passes through the lenses 52-53, the aperture 54a of the aperture stop 54, the lens 55, the aperture 56a of the illuminating field stop 56 and the lens 57 and is reflected by the dichroic mirror 58 and led to the observing optical system (26-28). Thereafter, the excitation light reaches the specimen 25 through the objective lens 26 (Koehler illumination).

Illumination area 25b of the specimen 25 in the observing illumination optical system (51-58) is similar in figure to the aperture 56a of the illuminating field stop 56 and has a circular shape with a large diameter whose center is on the optical axis 20a of the observing optical system (26-28). The specimen 25 is excited within the illumination area 25b and radiates fluorescence from the illumination area 25b.

At a fluorescence observation of the specimen 25, fluorescence radiated from the in-focused specimen 25 is converged on the given image plane 29 conjugate with the position of the in-focused specimen 25 by the objective lens 26 and the image-forming lens 27. In this case, a fluorescence image of the specimen 25 is clearly formed on the image plane 29.

On the given image plane 29 (or a plane conjugate with image plane 29), though not shown, a two-dimensional imaging element (for example, CCD imaging sensor) is disposed. When the specimen 25 is in focus, a clear fluorescence image of the specimen 25 can be obtained by the two-dimensional imaging element.

The focus point detection device 40 arranged in the fluorescence microscope 50 so configured as in the foregoing is explained. The focus point detection device 40 is to detect whether or not the specimen 25 is in focus.

The focus point detection device 40 has an illuminating optical system (16,41,42) and a light receiving optical system (20,21,43-45). Further, the objective lens 26 of the fluorescence microscope 50 acts as the focus point detection device 40. Thus, as constituent elements of the focus point detection device 40, not only the illuminating optical system (16,41,42) and the light receiving optical system (20,21,43-45), but also the objective lens 26 is included.

The illuminating optical system (16,41,42) is configured in such a way that the light source 41, the illuminating field stop 16 and the dichroic mirror 42 are orderly arranged along on the optical axis 40a. The light receiving optical system (20,21,43-45) is configured in such a way that the reflection mirror 44, the image-forming lens 43, the wavelength selection filter 45, the light sensing field stop 20 and the photoelectric detector 21 are arranged in order along on the optical axis 40a.

The light receiving optical system (20,21,43-45) is arranged in between the objective lens 26 of the observing optical system (26-28) and the dichroic mirror 58 of the observing illumination optical system (51-58) with the optical axis 40b of the light receiving optical system (20,21,43-45) being approximately normal to the optical axis 20a of the observing optical system (26-28). In this case, the reflection mirror 44 of the light receiving optical system (20,21,43-45) is disposed on the optical axis 20a.

The illuminating optical system (16,41,42) is arranged in between the image-forming lens 43 and the wavelength selection filter 45 of the light receiving optical system (20,21,43-45) with the optical axis 40a of the illuminating optical system (16,41,42) approximately normal to the optical axis 40b of the light receiving optical system (20,21,43-45). In this case, a dichroic mirror 42 of the illuminating optical system (16,41,42) is disposed on the optical axis 40a.

In the illuminating optical system (16,41,42) and the light receiving optical system (20,21,43-45) so configured as in the foregoing, the light source 41 is provided instead of the light source 11, the lenses 12-13, the aperture stop 14 and the lens 15 of FIG. 1. The image-forming lens 43 functions as the lens 17 and image-forming lens 27 of FIG. 1. The dichroic mirror 42 acts equally as the dichroic mirror 18 and the wavelength selection filter 45 also functions equally as the wavelength selection filter 28. Arrangement of the illuminating field stop 16, the light sensing field stop 20 and the photoelectric detector 21 and shapes of the apertures 16a and 20b are as described in the foregoing.

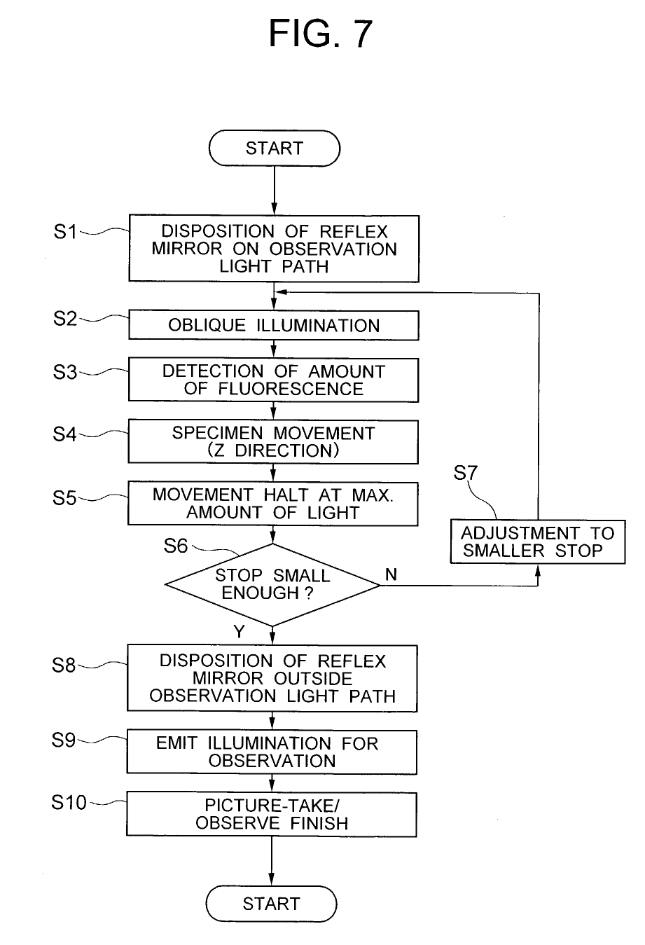

In other words, characteristic differences of the focus point detection device 40 of the third embodiment from the focus point detection device 10 reside in the location of the light source 41 and a switching control of illumination timing (FIG. 7) by the reflection mirror 44. These characteristics will be explained next.

The light source 41 is a compact semiconductor laser, LED or the like and emits excitation light such as ultraviolet rays, visible light rays and so on. The light source 41 is disposed close to the aperture 16a of the illuminating field stop 16 with an emitting direction of the excitation light oblique to the optical axis 40a.

Thus, excitation light from the light source 41 advances in an oblique direction to the optical axis 40a (excitation light L2) even after passing through the aperture 16a of the illuminating field stop 16 and reaches the dichroic mirror 42. Excitation light reflected upon the dichroic mirror 42 passes through the image-forming lens 43, and then is reflected upon the reflection mirror 44 and reaches the specimen 25 via the objective lens 26. Namely, the excitation light illuminates the specimen 25 obliquely.

The specimen 25 obliquely illuminated gets excited within slit-shaped illumination area 25a and generates fluorescence from the illumination area 25a. This fluorescence is reflected upon the reflection mirror 44 after passing through the objective lens 26 and reaches the image-forming lens 43. And the fluorescence transmits through the dichroic mirror 42 and the wavelength selection filter 45 and reaches the light sensing field stop 20.

Also, in the focus point detection device 40, the dichroic mirror 42 and the wavelength selection filter 45 are disposed between the objective lens 26 and the light sensing field stop 20, so light reflected by the specimen of the excitation light (for example, wavelength of less than 505 nm) to the specimen 25, can be shut off, and only the fluorescence (for example, wavelength 520 nm-600 nm) generated at the specimen 25 can be efficiently led to the photoelectric detector 21.

The foregoing illuminating optical system (16,41,42), image-forming lens 43, reflection mirror 44 and objective lens 26 composes an illuminator. The objective lens 26, light receiving optical system (20,21,43-45) and dichroic mirror 42 composes an image-forming device.

A principle of the focus detection by the focus point detection device 40 of the third embodiment is the same as that of the foregoing focus point detection device 10 (see FIGS. 2A-3) and a focus point detection can be performed, by monitoring change in the amount of light detected by the photoelectric detector 21 while moving the specimen 25 in the Z direction. Thus, a point (a point Zb in FIG. 3) where the detected amount of light reaches a peak is judged to be the position of the in-focused specimen 25.

As described above, the focus point detection device 40 of the third embodiment, a focus point detection is performed by monitoring change in the amount of light of the fluorescence image of the specimen 25, so the focus point detection can be optimally executed even if the amount of light from the specimen 25 is dim or so small.

In the foregoing embodiments, explanation has been made regarding the case of wavelength less than 505 nm with respect to excitation light and wavelength of 520-600 nm with respect to fluorescence, but this invention is not limited to such a case. This invention is applicable to a case where the wavelength of illumination light is different from that of return light from a specimen. For example, in a case where an image from a specimen is detected by a so-called two-photon absorption phenomenon in which a same fluorescence phenomenon as a case where a specimen is illuminated with excitation light of 340 nm is obtained by irradiating the specimen with a high-brightness light of 680 nm intensively, fluorescence with a shorter wavelength than that of excitation light is generated. But if a dichroic mirror has a charcteristic that light having wavelength more than 650 nm is reflected and light whose wavelength is less than 650 nm is transmittable, is used a focus point can be detected with use of a focus point detection device of the present invention. In this case, if a wavelength selection filter transmitting only a wave band of 400 nm-600 nm is disposed on a light sensing side, a light sensing efficiency can be further enhanced

Next, a switching control of illumination timing (FIG. 7) by the reflection mirror 44 is explained by referring to a flow chart of FIG. 7. This switching control is executed by a control device (not shown) responsible for an overall control of the fluorescence microscope 50. The control device composes a switching controller. At detection of a focus point, a two-step adjustment to width of the aperture 16a of the illuminating field stop 16 and to width of the aperture 20b of the light sensing field stop 20 is also made by this control device.

The control device, to begin with, disposes the reflection mirror 44 onto the optical axis 20a of the observing optical system (26-28) (step S1) and illuminates the specimen 25 obliquely (step S2). In this case, width of the aperture 16a of the illuminating field stop 16 and width of the aperture 20b of the light sensing field stop 20 are set to a broad width state of the curve (a) in FIG. 4. Then, fluorescence is generated from the slit-shaped illumination area 25a of the specimen 25 and an image is formed on the light sensing surface 21b of the photoelectric detector 21 by fluorescence passing through the aperture 16a of the light sensing field stop 16. That is, the amount of fluorescence is detected by the photoelectric detector 21 (step S3).

The control device, while monitoring the amount of light detected by the photoelectric detector 21, moves the specimen 25 in the Z direction (step S4) and halts the specimen 25 at a point (step S5) where the amount of light detected by the photoelectric detector 21 becomes at a maximum. In this stage, as shown by the curve (a) in FIG. 4, the rough focus point detection within a broad focus point detection scope (ΔZ1) finishes. Next, the control device judges whether or not width of the aperture 16a of the illuminating field stop 16 and width of the apertures 20b of the light sensing field stop 20 are sufficiently narrow (step S6) and when not sufficiently, widths of the apertures 16a and 20b get further narrowed (step S7). The processing from steps S2 to S6 are performed repeatedly.

Thus, widths of the apertures 16a and 20b are changed to narrow ones ((b) in FIG. 4), and the focus point detection is performed in a narrow focus point detection scope (ΔZ2). As a result, a detected amount of light becomes at a peak and the movement of the specimen 25 is halted at an in-focus point (step S5), and thus, the highly accurate focus point detection finishes.

Once the control device finishes the focus point detection with sufficient narrow widths of the aperture 16a of the illuminating field stop 16 and the aperture 20b of the light sensing field stop 20, a flow proceeds to step S8 and the reflection mirror 44 is disposed off the optical axis 20a of the observing optical system (26-28). As a result, the oblique illumination of the specimen 25 by the focus point detection device 40 finishes.

To further speed up detection of an in-focus point, the following way is available.

As a slit to be projected is illuminated obliquely in the widthwise direction of the slit, an illumination position deviated in the widthwise direction as the specimen moves in the height direction. As the amount of deviation or shift is proportional to the amount of movement in the height direction from the in-focus point, the amount of detected light becomes a maximum level at the in-focus point and it decreases in the forward and rearward directions from the in-focus point in a way of a linear function. Thus, if the amounts of light of at least two points in front of and behind the in-focus point are measured and changes in the measured amounts of light in front of and behind the point in focus are approximated to straight lines, a meeting point of the lines turns out to be the in-focus point. Therefore, measurements of amounts of light at at least four points in total, that is, at two points in the “front focus” state and two points in the “rear focus” state, enable to detect the in-focus point. If measuring points are increased in number and a straight line is approximated by method of least squares, noise or a mechanical error can be decreased so that more accurate focus point detection may be performed.

Under this configuration, the control device controls the observing illumination optical system (51-58) to illuminate a broad area of the specimen 25 (illumination area 25b) (step S9). As the specimen 25 is in focus, fluorescence generated from the illumination area 25b of the specimen 25 is converged on the imaging plane 29 conjugate with the position of the in-focused specimen 25 through the objective lens 26 and the image-forming lens 27. Then, a clear fluorescence image of the specimen 25 is formed on the imaging plane 29.

Thus, the control device can obtain a clear fluorescence image of the specimen 25 by the two-dimensional imaging sensor (for example, CCD imaging sensor) disposed on the imaging plane 29 (or a plane conjugate with the imaging plane 29) (step S10).

Like this, in the fluorescence microscope 50 of the third embodiment, illumination timing of the oblique illumination of the focus point detection device 40 and another illumination timing of the observing illumination optical system (51-58) are alternated, so an optimum focus point detection becomes possible in a short time even if the amount of fluorescence radiated from the specimen 25 is dim or so small and a highly accurate fluorescence observation of the specimen 25 can be realized.

Light source 41 may be disposed via a beam expander or a collimator although light source 41 only is disposed adjacent to the aperture 16a of the illuminating field stop 16 in the foregoing third embodiment.

In the foregoing embodiments, the observing illumination optical system and the illuminating optical system of the focus point detection device are separately provided and the reflection mirror is used to change over illumination timing. However, this invention is not limited only to this configuration.

For example, in a case where the illuminating optical system of the focus point detection device for use in the fluorescence microscope is such configured as that (11-18) of FIG. 1, the foregoing illuminating optical system can be used also as the observing illumination optical system and illumination timing can be switched over by adjusting the location and shape of apertures 14a and 16a of the aperture stop 14 and the illuminating field stop 16.

In other words, at detection of a focus point, a location and shape may be set just like those of apertures 14a, 16a in FIG. 1 and also at a fluorescence observation, the same as those of apertures 54a and 56a of FIG. 6. Instead of adjustments to the locations and shapes of apertures 14a, 16a, the aperture stop 14 and the illuminating field stop 16 may be replaced.

Further, when changing a scope of the focus point detection and accuracy in the focus point detection, widths of apertures 16a and 20b of the illumination field stop 16 and the light sensing field stop 20 are adjusted, but instead of such an adjustment, the illumination field stop 16 and the light sensing field stop 20 may be replaced.

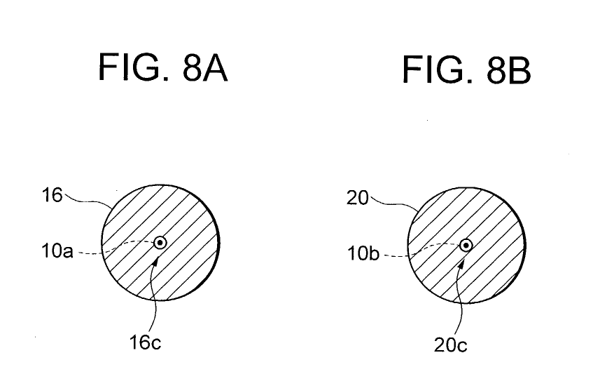

In the foregoing embodiments, the apertures 16a and 20b of the illumination field stop 16 and the light sensing field stop 20 are slit-shaped. But as shown in FIGS. 8A and 8B, the illumination field stop 16 and the light receiving field stop 20 may be formed with small circular (spot-shaped) apertures 16c and 20c, respectively. In this case, an illumination area of the specimen 25 is also a small circular shape. As a result, a location of the in-focused specimen 25 can be narrowed down and a location of an object under observation can be specified.

Further, in the foregoing embodiments, the size of the fluorescence image (which corresponds to the illumination area of the specimen 25) on plane which the light sensing field stop 20 is disposed, is made coincide with the size of aperture 20b, but this invention can be applied to a case where the size of the fluorescence image is different from that of aperture 20b. Also, in the foregoing embodiments, the focus position detection device is provided with the light sensing field stop 20, but the light sensing field stop 20 may be omitted in a case of the objective lens 26 of the observing optical system (26-28) being fixed.

Further, in the foregoing embodiments, a photoelectric detector for collectively detecting the amount of fluorescence entering a light sensing surface has been explained as an example, but this invention is not limited to such detector. For example, a photoelectric detector may be so configured in such a way that the amount of fluorescence is divided and each divided amount of fluorescence is detected, and then, a total sum of each detected amount of fluorescence is taken in a later signal processing system.

In the foregoing embodiments, the aperture stop 14 (FIG. 1) is disposed on a position conjugate with a pupil plane of the objective lens 26, but this invention can be applied to a configuration with an aperture stop being disposed somewhere away from the pupil plane and a specimen can be illuminated obliquely.

In the foregoing three embodiments, an illumination light has been guided via an objective lens for an image-forming device, but this invention may be realized by guiding an illumination light via other than an objective lens. Also, in the foregoing three embodiments, a focus point detection device for a fluorescence observation and a microscope using the focus point detection device have been referred to as an example, but this invention may be applicable to even a case where wavelength bands of an illumination light and a detection light are same. For instance, it is a case where focus point detection regarding a light scattering material of an observed specimen is performed. In this case, by eliminating a regular reflection light from a specimen with a stop or by guiding an illumination light via other than an objective lens and disposing an optical system of an image-forming device in a direction with no regular reflection light incident from a specimen, selective detection of a light from a light scattering material becomes possible. It is needless to say that this invention can be applied to not only a fluorescence observation, but also a case where a wavelength of an illumination light is different from a wave band of a detection light.

As explained in the foregoing so far, optimum focus point detection can be performed even in a low amount of light from an object.

What is claimed is:

1. A focus point detection device comprising:
an illuminator that illuminates a specimen obliquely by letting a light flux at an angle to an optical axis of an objective lens enter in such a way that the optical axis and the light flux cross each other in the vicinity of a point in focus at an object side of the objective lens,
an image-forming device that forms an image of an observation plane by converging a light from the observation plane of the specimen via the objective lens
and
a light amount detector that detects amount of light in response to the image formed by the image-forming device with a light sensor, wherein
the light amount detector detects a light other than a regular reflection light from a surface of the specimen.

2. The focus point detection device set forth in claim 1, wherein
a light sensing field stop is disposed on a plane conjugate with an in-focus point and
the light amount detector detects amount of light with the light sensor disposed behind the light sensing field stop via the light sensing field stop.

3. The focus point detection device set forth in claim 2, wherein
the illuminator includes an illumination field stop defining an illumination range of the observation plane and
the illumination field stop is similar in figure to the light sensing field stop.

4. The focus point detection device set forth in claim 3, further comprising:
an adjuster that adjusts sizes of the illumination field stop and the light sensing field stop.

5. The focus point detection device set forth in claim 2, further comprising:
an auxiliary light sensor and
an auxiliary light sensing field stop respectively disposed behind a plane conjugate with the in-focus point and
a direction detector that detects a direction of a shift in position of the specimen in response to amount of light entering the auxiliary light sensor.

6. The focus point detection device set forth in claim 1, wherein
the illuminator is to illuminate the observation plane obliquely via an objective lens of an infinity optical system and includes
an aperture stop on a location conjugate with a pupil plane of the objective lens.

7. The focus point detection device set forth in claim 6, wherein
the aperture stop includes an aperture off an optical axis of the pupil plane.

8. The focus point detection device set forth in claim 1, wherein
a photomultiplier is used as the light amount detector.

9. The focus point detection device set forth in claim 1, wherein
the light amount detector approximates changes in amount of light in front of and behind a point in focus to straight lines respectively and let a meeting point of two straight lines be a point in focus.

10. The focus point detection device set forth in claim 1, wherein
an optical axis of the image-forming device is approximately normal to the observation plane.

11. A microscope comprising:
the focus point detection device set forth in claim 1, wherein
the objective lens is an infinity optical system.

12. The microscope set forth in claim 11, further comprising:
a switching controller that switches between illumination timing by the illuminator of the focus point detection device and illumination timing by the observing illuminator.

13. The microscope set forth in claim 12, wherein
the illuminator of the focus point detection device includes an aperture stop disposed on a location conjugate with a pupil plane of the objective lens and
the switching controller is to detach the aperture stop out of an optical axis of the illuminator.

14. A focus point detection device comprising:
an illuminator that illuminates a specimen obliquely,
an image-forming device that forms an image of an observation plane by converging a light from the observation plane of the specimen via an objective lens and
a photoelectric detector that detects amount of light in response to the image formed by the image-forming device with a light sensor, wherein
an illumination light illuminated by the illuminator is different in a wave band from a detection light entering the light sensor.

15. The focus point detection device set forth in claim 14, wherein the image-forming device includes
a wavelength selector.

16. A microscope comprising:
the focus point detection device set forth in claim 15, wherein
the objective lens is an infinity optical system,
the illuminator illuminates the observation plane obliquely and
the image-forming device forms an image of the observation plane via the objective lens.

17. The microscope set forth in claim 16, further comprising:
an observing illuminator that illuminates the specimen via the objective lens with a light for observation when observing the observation plane and
a switching controller that switches between illumination timing by the illuminator of the focus point detection device and illumination timing by the observing illuminator.

18. The microscope set forth in claim 17, wherein
the illuminator includes an aperture stop on a location conjugate with a pupil of the objective lens and
the switching controller is to detach the aperture stop out of an optical axis of the illuminator.

19. A focus point detection device comprising:
an illuminator that illuminates a specimen obliquely,
an image-forming device that forms an image of an observation plane by converging a light of the observation plane of the specimen via an objective lens and
a light amount detector that detects amount of light in response to the image formed by the image-forming device with a light sensor, wherein
the illuminator illuminates the specimen obliquely with a light of a wave band enabling to excite fluorescent material contained in the observation plane and
the light amount detector detects amount of fluorescence entering the light sensor.

20. A fluorescence microscope comprising:
an objective lens of an infinity optical system and
the focus point detection device set forth in claim 19, wherein
the illuminator illuminates the observation plane obliquely via the objective lens and
the image-forming device forms the fluorescence image of the observation plane via the objective lens.
